(19) United States
(12) Patent Application Publication
(10) Pub. No.: US 2013/0238511 A1
(43) Pub. Date: Sep. 12, 2013

(54) SYSTEM AND METHOD FOR END-OF-LIFE PROCESSING OF AN AIRFRAME

(71) Applicant: Sjoerd VAN DER VEEN, Tournefueille (FR)

(72) Inventor: Sjoerd VAN DER VEEN, Tournefueille (FR)

(73) Assignee: AIRBUS OPERATIONS SAS, Toulouse (FR)

(21) Appl. No.: 13/415,313

(22) Filed: Mar. 8, 2012

(51) Int. Cl. G06Q 10/04; G06G 7/57; G06G 7/70

(52) U.S. Cl. 705/306; 703/8

(57) ABSTRACT

A method to develop a plan to dismantle an airframe including: enhancing a digital mock-up model (DMU) of the airframe with data identifying hazardous materials in parts of the airframe; positioning at least one cut through the DMU of the airframe; based on the position of the cut, identifying intersections between the cut and fluid conduits identified in the DMU of the airframe; analyzing the identified intersections of the fluid conduits and data regarding hazardous waste fluids in the conduits of the airframe to identify the conduits having the hazardous waste which would be ruptured by the positioned cut, and generating a report of the identified conduits that would be ruptured and have the hazardous waste.

### BACKGROUND OF THE INVENTION

This invention relates to end-of-life management of aircraft and particularly to maximizing the monetary value of an aircraft at the end of its operational life.

An aircraft that has reached the end of its operational life continues to have value as a source of recyclable aircraft parts and materials that may be sold as scrap. The value of recycled parts and scrap material is offset by the costs of dismantling the aircraft and disposing of hazardous materials in the aircraft.

At the end of its life, the aircraft is shipped to a location where it is dismantled. If the engines have been removed, the aircraft is typically referred to as an airframe. The airframe is most often dismantled to recover recyclable parts and scrap material. The end-of-life management system is described here in the context of an entire airframe, but is equally applicable to an aircraft or a portion of the airframe or aircraft.

Determining the value of recyclable aircraft parts and scrap material in the airframe has been a manually intensive process. The determination is typically performed by a person(s) supervising the disassembly (the “disassembler”). This person determines where to section, e.g., cut, the airframe, which parts should be recovered and recycled and the portions of the airframe to be sold as scrap. The disassembler makes these determinations based on an inspection of the airframe, manuals (which may be electronic) for the airframe and other information published by the airframe manufacturer, and the value of parts on a market for used aircraft parts. The disassembler relies heavily on his expertise and historical experience in dismantling airframes.

An aircraft is typically many years old when it reaches the end of its operational life. Due to its old age, information about the assembly of the airframe and its parts is typically difficult to obtain during the end-of-life process. The disassemblers often do not have access to the assembly plans and other information used by the airframe manufacturer to assembly the parts of the airframe.

The information available to the disassembler may not be sufficient to accurately estimate the cost of recovering a part from an airframe. Much of the information used to estimate the cost of recovery is based on visual inspection of the airframe. Reliable estimates of the costs of recovering a part conventionally rely heavily on the expertise of the disassembler who makes the estimates.

Selecting the locations where the airframe is to be cut is traditionally a determination made by the disassembler based on an inspection of the airframe. Cutting of the airframe into sections often destroys potentially valuable recyclable parts and ruptures conduits holding hydraulic fluid and other hazardous fluid. These undesirable results may be exasperated by a lack of information available to the disassembler about the airframe and specifically information that would assist in making cuts to the airframe that minimize destruction of parts and rupturing of conduits.

Selecting parts from the airframe for recovery and recycling is typically based on the value of the parts. To determine a market price of a part, the disassembler may look for part pricing information on electronic commerce bidding service. The true value of a part is often the difference between the market price for the part and the cost of recovering the part from the airframe. The disassembler estimates the cost of recovering the part from the airframe based on his expertise and prior experience in recovering similar parts. The disassembler may also roughly estimate the cost of treating hazardous wastes associated with recovering a part and use the estimate in determining the value of recycling the part.

Another cost associated with recovering parts from an airframe is the cost of handling the hazardous wastes in the airframe. The disassembler often has little information about the hazardous materials in an airframe. The cost of waste disposal of hazardous materials is often a large portion of the cost of disposing of an airframe. Hazardous materials in an airframe typically include hydraulic fluid, oil, fuel, battery acids, fluids in refrigeration systems, compositions of coatings on parts and certain solid materials, such as used in electronic gear. A wide variety of different types of hazardous materials, or materials that cannot be recycled together, may be in an airframe. The hazardous materials are likely distributed at various locations throughout the airframe.

Disassemblers often have little or imperfect information regarding the locations in the airframe of hazardous materials, the types of hazardous material in the airframe and the amount of hazardous material. Finding the hazardous materials and identifying the materials is time consuming and expensive.

Modern aircraft are designed using digital mock-up (DMU) models created with three-dimensional Computer Aided Design (3D CAD) software systems. DMU models of an airframe specify the location for each part, connections between parts, conduits for fluids and generate images of the airframe from various viewpoints, including cross-sectional vies and views of internal components of the aircraft. DMUs are conventionally developed to assist in the design and manufacture of an aircraft. DMUs have historically not been developed to support the disassembly of an aircraft at the end of its life.

DMU models are potentially helpful in disassembling an aircraft. The DMU contains information regarding the identification of parts, the location of parts in the airframe and the interconnections between parts. This information would be assist in determining how best to disassemble the airframe. While DMU models have some information helpful to the disassembly of an airframe, they do not contain all of the information about an airframe that would aid in the dismantling of the airframe.

There is a long felt and need for software based systems, such as enhanced DMU models, to assist in disassembling of airframes, determining the value of recycling parts in the airframe and the scrape value in the airframe, and to estimate the costs associated with recovering parts and scrap materials from an airframe.

### BRIEF DESCRIPTION OF THE INVENTION

A software based management system and method have been conceived to manage the dismantling and sale of an airframe at the end of its life. The system identifies the locations of parts having hazardous materials in an airframe, is helpful locating cuts to be made to the airframe that minimize destruction of parts and release of hazardous fluids, assists in determining whether parts have sufficient value to justify recovery and processing of hazardous materials, and assists in determining an optimal disassembly process to recover parts from an airframe at minimal cost.

The system and method collects and stores information relevant to dismantling the airframe during the design and manufacturing phase of the airframe. Collecting and storing information during the design and manufacturing phase allows information to be captured for later use at the end of the life of the airframe. The operational life of an airframe is usually many years or decades. The end-of-life may occur after the airframe is no longer being manufactured and much of the information and expertise regarding the parts and materials used to make the parts of the airframe are no longer readily accessible.

The management system and method can be used to solve the problems that arise in planning the dismantling an airframe for recycling. The problems which the management system and method can be applied to solve include: identifying and locating hazardous materials in the airframe; assessing the amount hazardous materials at each location; identifying and locating reusable systems and parts in the airframe; cutting the airframe without damaging valuable parts; making cuts through the airframe that maximize scrap value of cut sections of the aircraft; minimizing spills of hydraulic fluids when cutting the airframe; recovering parts from the airframe, and determining value of potentially recoverably parts by based on the market price of the recoverable parts and for the scrap value of the cut airframe and deducting the costs of cuts, recovery of parts and treating hazardous materials.

A method has been conceived to develop a plan to dismantle an airframe including: enhancing a digital mock-up model (DMU) of the airframe with data identifying hazardous materials in parts of the airframe; positioning at least one cut through the DMU of the airframe; based on the position of the cut, identifying intersections between the cut and fluid conduits identified in the DMU of the airframe; analyzing the identified intersections of the fluid conduits and data regarding hazardous waste fluids in the conduits of the airframe to identify the conduits having the hazardous waste which would be ruptured by the positioned cut, and generating a report of the identified conduits that would be ruptured and have the hazardous waste.

The method may reduce the number of ruptured conduits having hazardous wastes by shifting the at least one cut to another location on the airframe, and repeat the steps of indentifying the intersections, analyzing the identified intersections and generating a report based on the cut at the another location.

The method may also calculate a value of at least one part in the section based on a market price for the part from which is deducted a cost of removal of the part from the airframe and a cost of treating the hazardous waste associated with recovering the part.

The enhancement of the DMU may occur before the airframe is placed in service and the identification of the cuts to the airframe may occur during end-of-life processing of the airframe.

A system has been conceived for planning a dismantling of an airframe comprising: a computer system having a non-transitory memory storing a software system which causes the computer system to: enhance a digital mock-up model (DMU) of an airframe, with data identifying hazardous materials in parts of the airframe; position at least one cut through the DMU of the airframe; based on the position of the cut, identifying intersections between the cut and fluid conduits identified in the DMU of the airframe; analyze the identified intersections of the fluid conduits and data regarding hazardous waste fluids in the conduits of the airframe to identify the conduits having the hazardous waste which would be ruptured by the positioned cut, and generate a report of the identified conduits that would be ruptured and have the hazardous waste.

### BRIEF DESCRIPTION OF THE DRAWINGS

FIG. 1 is a top level flow chart of an exemplary method for managing the dismantling of an aircraft.

FIGS. 2 to 4 show a detailed flow chart for managing the dismantlement of an aircraft.

FIG. 5 is a schematic diagram of a software based system to implement the methods shown in FIGS. 1 to 4.

### DETAILED DESCRIPTION OF THE INVENTION

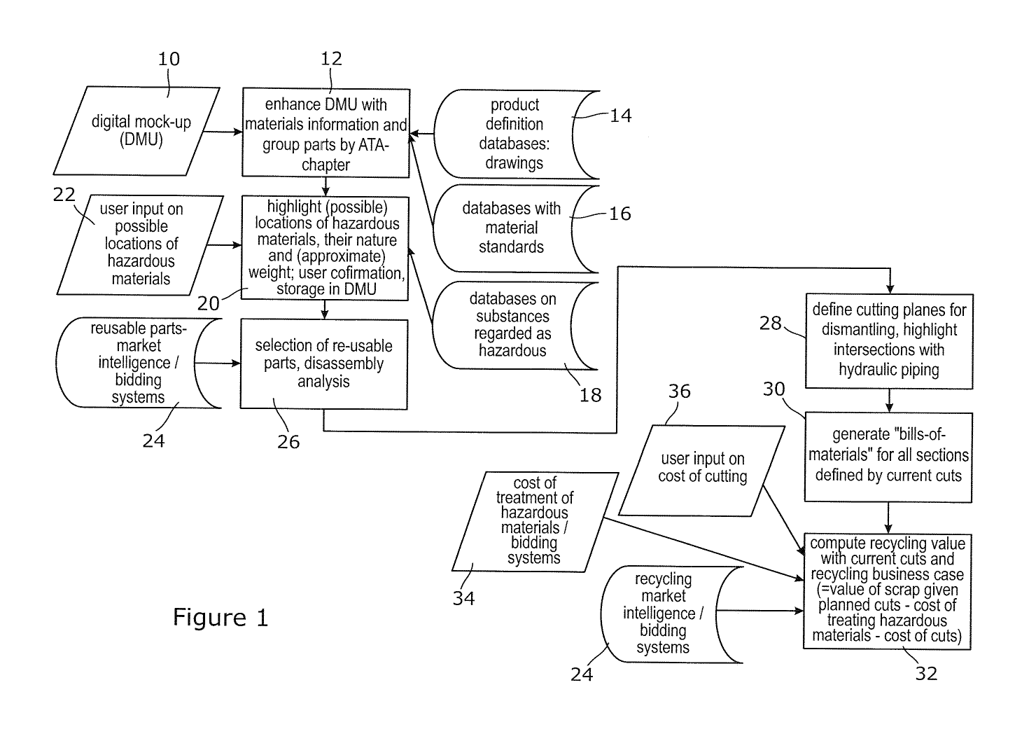

FIG. 1 is a top-level flowchart illustrating an exemplary method and system for managing the end-of-life process for an airframe. The system illustrated in the flow chart is a software system, such as a software program, system or module, having the functionally described in the flowcharts. The software system may be used by disassemblers to plan the dismantling of an airframe and estimate the value of the airframe.

A digital mock-up (DMU) 10 of the airframe is generated and stored electronically. The DMU may be a digital model of the airframe and include information identifying each part in the airframe and the position of the part in the airframe. DMUs have conventionally been used to model airframes and the parts of an airframe.

The DMU 10 is enhanced 12 by, for example, being linked to databases 14, 16 storing detailed information regarding the parts in an airframe. The DMU may link to and access a database(s) 14 having product definitions of each part in the airframe. The database 14 with product definitions may include information identifying the product, the shape of the product, e.g., drawing information, and information indicating the relationship the part has with other parts in the airframe.

Additional databases may provide information for assigning identifying information to each part in the airframe, wherein the indentifying information conforms to industry standards for part identifiers. For example, ATA Chapter numbers provide a common and well-recognized numbering system to assign identifying reference numbers to each part in an airframe. The enhanced DMU 12 may categorize the potentially recoverable parts in the airframe using references based on industry standard naming conventions, such as the ATA Chapter numbers.

The enhanced DMU may also have access to a database 16 having information regarding materials used to form the parts of the airframe. The database 16 having information on materials includes detailed information indicating the composition of each part, such as the specific metal alloy of the part and chemicals used to treat the part.

The enhanced DMU 12 correlates information regarding the materials used in parts with the database 18 of information regarding the hazards of materials to identify the parts having hazardous materials and associate with each part hazardous material information corresponding to the material in the part. The hazardous material information includes the identification of parts having hazardous materials, the location of the hazardous materials in the airframe, e.g., the part locations, the nature of the hazardous material and the weight or other indication of the amount of the hazardous material. For example, a software system 20 may, for each part in the airframe, access the databases with parts information and material information and determine which parts have hazardous materials. Based on this determination, the DMU stores information regarding the parts in the airframe having hazardous materials.

A person knowledgeable of recycling hazardous materials in the airframe provides supplemental information 22, such identifying parts and conduits having hazardous materials and a proper manner in which hazardous materials may be removed from the aircraft. This person may review the parts in the airframe that the enhanced DMU has determined to have hazardous materials and add comments or other information to the enhanced DMU confirming that the parts have hazardous materials. The person may add comments or other information regarding risks associated with handling parts having hazardous materials and suggestions to handle the parts with hazardous materials.

The enhanced DMU 12 includes or has access to information regarding parts and the materials making up the parts, the identification of hazardous materials in the parts, and the comments and information regarding recycling and handling the parts with hazardous materials. The enhancements to the DMU may be added during the design of the airframe or other event before, at or near the start of the life of the airframe. Capturing information about hazardous materials in the airframe in the enhanced DMU at the design or manufacturing phase for an airframe is advantageous because this information tends to be readily available at these phases as compared to the end-of-life phase of the airframe.

The enhanced DMU with the information regarding recycling parts, including parts having hazardous materials, is available when the airframe is taken out of service and starts its end-of-life processing. During the end-of-life processing, the enhanced DMU is used to provide information to section and disassemble the airframe, and recover parts from the airframe. The enhanced DMU provides information helpful in sectioning the airframe and selecting parts that may be recycled, such as by being refurbished, rebuilt or from which valuable materials may be recovered.

To assist in determining the value of parts in the airframe, the enhanced DMU accesses a database(s) or other electronic commerce information systems 22 having current information regarding markets for recycled aircraft parts. These electronic commerce information systems 22 may be electronic trading centers which market aircraft parts. By accessing the database(s) and electronic commerce information systems, the enhanced DMU makes available information related to the current value of the parts in the airframe. The information regarding the resale value assists in determining whether it is economical to disassemble an airframe and which parts of an airframe have sufficient value to justify being refurbished, rebuilt or otherwise recycled.

The electronic model of the airframe provided by the enhanced DMU is used to plan 26 a dismantling procedure for the airframe undergoing end-of-life processing. The dismantling plan includes instructions and drawings for cutting the airframe into sections, removing valuable parts and rendering the remaining portions of the airframe section suitable for the scrap market. The cutting locations on the airframe are selected and adjusted to avoid damaging the parts that have been identified as having value and minimize the release of hazardous materials, such as hydraulic fluids, from conduits ruptured by cutting the airframe.

The drawings of the airframe generated by the enhanced DMU identify locations on the airframe to be cut or otherwise mechanically dissembled, in step 28. The drawings or other information generated by the DMU are used by the mechanics and other personnel to segment the airframe and recover parts for each segment. The drawings and other information generated by the DMU may indicate the manner in which the airframe is to be divided into sections for further disassembly.

The enhanced DMU generates reports 30 identifying the parts to be recovered from the airframe. The reports indicate the location of the part in the airframe, the type of part, the interconnections between the parts and the airframe, and provide instructions for removing the part from the airframe. Separate reports may be generated for each section of the airframe formed during the cutting or other disassembly of the airframe.

The reports of parts in each section of the airframe are used to determine which parts may be economically recovered from the sections. A computation 32 is made for each recoverable part by comparing the value of the part to the cost of recovering the part. For example, the computation deducts from the value of the part the costs of removing the part from the airframe and treating the hazardous materials associated with the part. The computation is made based on information obtained from databases 34 having information regarding the costs of treating the hazardous materials associated with a part or providing information for soliciting bids to have the hazardous material treated. In addition, the computations may receive information from a disassembler regarding the cutting of the airframe or access databases 36 storing expert information regarding the cost of recovering a part from the airframe, which may be referred to as a cost of “cutting” the part from the airframe.

The information regarding the resale value of the parts may be based on a bidding system 24 for the parts. For example, an inventory of recoverable parts may be maintained in an electronic commerce system which provides information regarding the parts to prospective purchasers of the parts. The electronic commerce system 24 may be a website listing the available parts. As a prospective purchaser submits bids for a part, the custodian of the airframe sections determines if the purchase price offered by the bidder is sufficient to justify recovering and selling the part. The determination of whether to sell the part is an informed determination because the custodian has access information regarding the estimated cost to recover the part and the cost for properly disposing of hazardous materials associated with the recovery of the part.

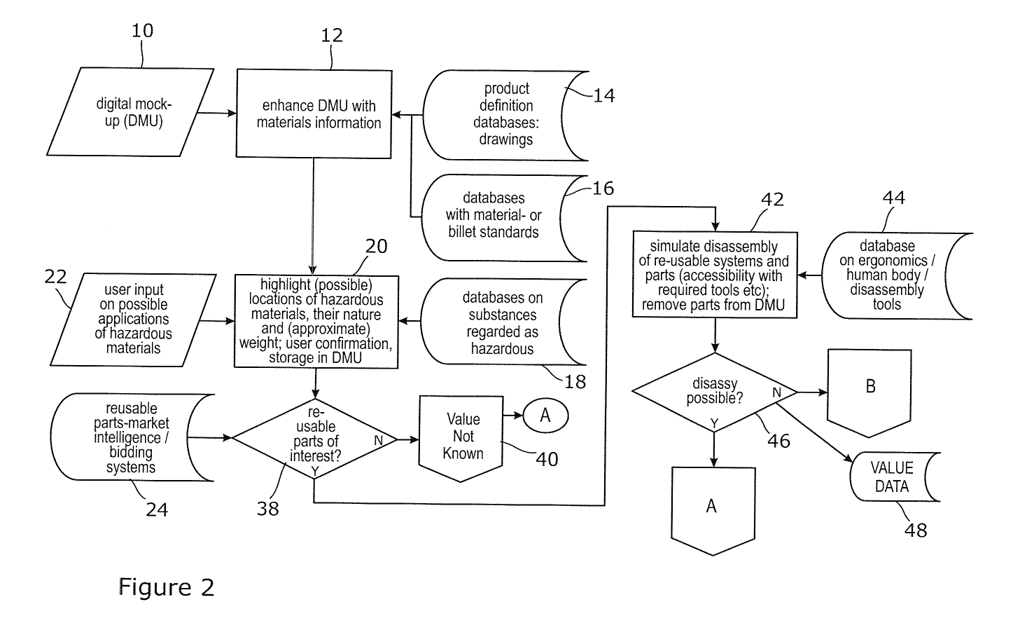

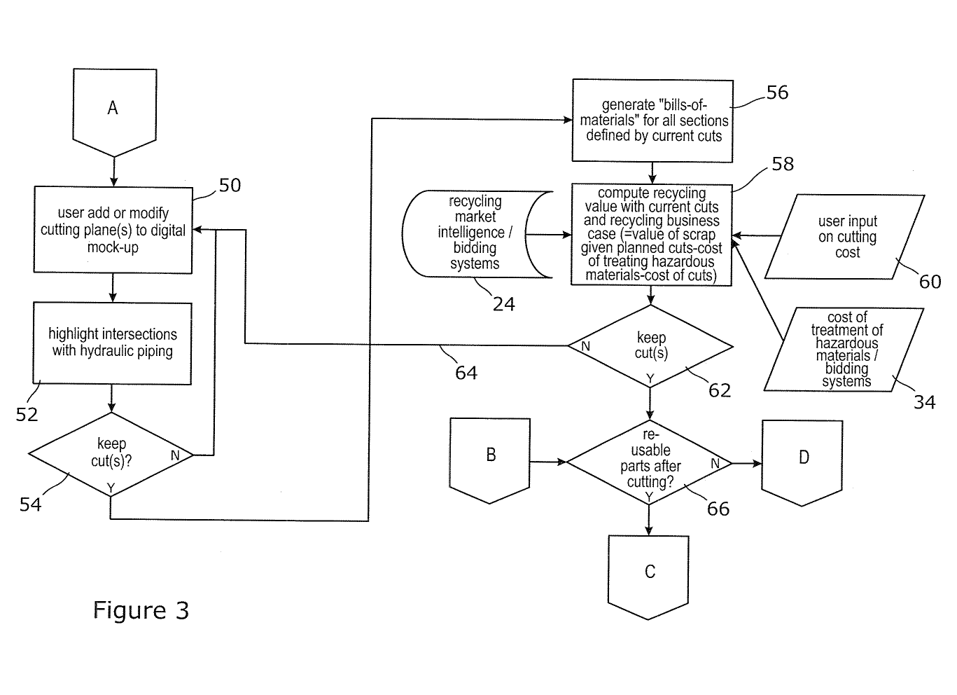

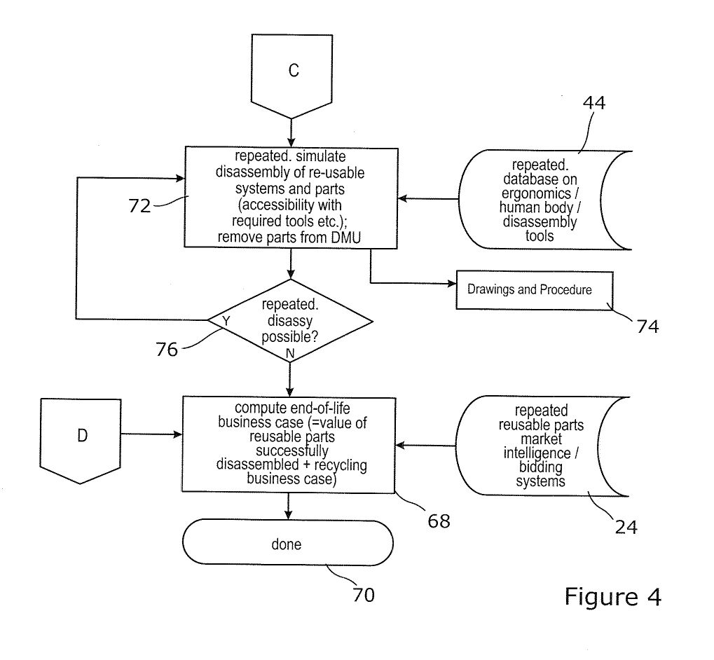

FIGS. 2 to 4 are a detailed flowchart of an exemplary software system 10 and a method for managing recovery of parts from an airframe at the end of its life. The system 10 may be included with or associated with an enhancement of the DMU model 12 of the aircraft. The digital mock-up (DMU) 10 models the aircraft such as with a three-dimensional (3D) computer aided design (CAD) model of the airframe. The DMU conventionally includes information for each part in the airframe, such as part numbers.

The information in the conventional DMU is insufficient to fully assist a person dismantle the airframe and recover the part from the airframe. For example, the part numbers conventionally included in a DMU may be proprietary to the manufacturer of the airframe. The person dismantling the airframe may not have access to the manufacturer's database of proprietary part numbers. Further, the part information in the unenhanced DMU may have incomplete information on the materials in each part, and the specification and drawings of the parts.

The DMU is enhanced to allow for better support for end-of-life processing of the airframe. The enhanced DMU may access or include part category information sufficient to assist a dismantler to recover parts from the airframe and identify hazardous materials associated with the parts.

The enhancement to the DMU may include entering into the DMU an industry standard part identification for each of the proprietary part numbers listed in the DMU. The DMU may also be enhanced by providing additional information about the materials, especially hazardous materials, forming the part. If some information on the material forming a part exists in the DMU, additional information may be added.

To enhance the DMU, an engineer or technician involved in the design of the airframe may review each of the parts listed in the DMU and add information to the DMU to assist end-of-life support of the airframe. The person may access databases 14, 16 maintained by the airframe manufacturer to link additional information to the DMU or add information to the DMU. These additional databases includes databases 14 storing part specifications, definitions and drawings; databases 16 storing information relevant to identifying parts according to industry standards for part classification, such as the ATA classification system; and databases 16 storing detailed information regarding materials in each part, such as specific metal alloys in a part.

The enhanced DMU includes or works with a software system which retrieves data from these other databases available to the airframe manufacturer. The software system may retrieve and display data regarding the materials in a aircraft part and a suggested part identifier compliant with an industry standard. A person using the software system, may select the displayed information and add the selected information to the DMU.

The software system may use a part number in the DMU to retrieve drawings of and specification for the part from a database 14 maintained by the manufacturer of the airframe. The software system, using information collected from the part drawings, may next access another database maintained by the manufacturer to retrieve detailed information regarding the specific materials in the part. The software system may next access databases 16 maintained by the manufacturer or external databases to retrieve information regarding the chemical composition, density or additional information on the materials in the part. The information about the part collected from the databases is stored in a database associated with the enhanced DMU to ensure that the information is available during end-of-life processing of the airframe.

The databases 14 having information to supplement the DMU may include a product definition database having drawings of each of the parts in the airframe and other information do define the part, such as manufacturing and certification data. The drawings of the parts may also include information regarding the materials used in the part.

Information on the materials in the parts is contained in a database 16 having the material standards for each material used in the parts. The material standards may be the definition of the material to be used in a part, and include ranges of acceptable alloys or chemical compositions used to make the parts. The database(s) on material standards may be proprietary to the manufacturer of the airframe or a publically available database, such as databases defining the compositions of different types and grades of metals.

The software system may search 20 for parts identified in the mock-up model of the airframe maintained by the enhanced DMU and search associated databases 14, 16 to identify parts having hazardous materials, such as passages for hydraulic fluid, petroleum based fluids or including hazardous materials. The software system may access the DMU to obtain information on the materials included in or associated with each part. This information on materials in a part is compared to a database(s) having information on hazardous materials. When a determination is made that a material in a part is hazardous, the software system may highlight the part and its hazardous material such as by displaying the information on a display screen of a computer terminal. The system also stores information about the hazardous material in databases associated with the enhanced DMU.

Expert knowledge 22 is applied to supplement the software system in identifying the hazardous materials in or associated with parts. For example, experienced technicians and maintenance engineers familiar with the aircraft type may identify hazardous materials that are applied to a part during the life of the airframe. These hazardous materials may remain on the part at the end-of-life of the airframe.

The enhanced DMU collects 20 the dismantling experience or other expert knowledge by, for example, storing information on hazardous materials that is applied to a part during the life of the airframe. The expert knowledge 22 is collected from industry standards, such as from procedures for repairing, maintaining and overhauling parts. These industry standards may have information about hazardous materials applied to a part during the life of an airframe. The information from the industry standards is captured in the enhanced DMU model.

The enhanced DMU aids the end-of-life processing of the airframe is substantially automated. The software tools highlights those parts having hazardous materials, such as showing the parts in a 3D representation of the part and airframe. A technician or engineer involved with the design, manufacture or repair of the aircraft, reviews 22 the highlighted parts to confirm the presence of hazardous materials. This confirmation is performed at various stages of the life of the airframe. The enhanced DMU stores the information on the parts with hazardous substances, and indicates whether and when the information had been confirmed.

To identify or confirm the presence of hazardous materials, each part listed in the DMU potentially having hazardous materials is highlighted, see step 20, in a sequential manner. Related groups of parts may be highlighted together. Related product groups may be determined based on the ATA industry standard identifying information which indicates the groups associated with a product. For a highlighted part or part group, the engineer or technician may access the drawing database to review detailed drawings of the product and may inspect the actual part. Based on his review of the drawing, inspection of the part and expert knowledge, the engineer or technician, see step 22, accesses the databases 14, 16, 18 having information about the materials in a part and confirms whether the materials associated with the part are hazardous materials. The engineer or technician enters or confirms information, see step 20, in the DMU model regarding whether the part has hazardous materials, the type of hazardous material and the amount of hazardous material. The software system stores the confirmed information to allow future re-highlighting of parts in the enhanced DMU.

The software system associated or included with the enhanced DMU may highlight, see step 20, parts having hazardous materials and automates many of the tasks associated with determining if hazardous materials are associated with a part in an airframe. The software system may periodically search and update the enhanced DMU during the life of the airframe. The software system may update information on parts in an airframe, as the parts are replaced and as repairs are performed on parts, especially where the repair applies hazardous materials to the part.

The software system may search for specific parts that are to be updated or to highlights parts for which a confirmation is needed as to the presence of hazardous materials. Using the software system, an engineer or technician confirms whether the highlighted part has a hazardous material, such as by physically inspecting the part, and updates the enhanced DMU with confirmatory information as to whether the part has a hazardous material.

The enhanced DMU model 12 stores detailed information regarding the parts in an airframe, the materials in the parts, and hazardous materials that are associated with the parts at the end-of-life of the airframe. The enhanced DMU may highlight those parts and the location of each part in the airframe having hazardous materials. The enhanced DMU may also indicate the nature of the hazardous material, the environmental threat presented by the hazardous material, the amount and weight of the hazardous material, and whether the information as to the hazardous material has been manually confirmed.

The enhanced DMU is shared with persons external to the airframe manufacturer, such as companies that specialize in the recovery of parts from end-of-life airframes, treat hazardous materials and otherwise handle the recovery and recycling of parts taken from airframes. The enhanced DMU model may be accessible remotely, such as by being accessible through a website providing access to the enhanced DMU model.

When evaluating an airframe at the end of its life, a person disassembling (a disassembler) selects 38 parts in the airframe that are viable candidates for recycling. The disassembler may use the enhanced DMU to access electronic commerce systems 24, e.g., auction or bidding markets, which have pricing information for recycled aircraft parts.

The identification and valuation of parts, see step 38, is automated by the enhanced DMU. The enhanced DMU determines whether the parts in the airframe, as identified by an industry standard classification system, are listed on an electronic commerce system and determining the price for such parts. If a valuation for a part cannot be determined 40 from an electronic commerce system, the DMU may proceed without determining the cost of recovering that part.

If a part has a valuation (see step 46), the DMU automatically proceed to determine the cost of recovering the part. The cost of recovery depends on the work and tools needed to remove the part from the airframe.

The software system for simulating 42 the disassembly of the airframe and removal of the part. The simulation of disassembly and removal 42 may be based on a reversal of an electronically stored process to assemble the part in the airframe that was been used to manufacture the airframe. Software systems that simulate the assembly of parts in an airframe and the ergonomics analysis of assembly of parts are conventional and well known. These existing software systems typically involve three-dimensional computer aided design (3D CAD) systems and databases of part assembly procedures.

The software system may access databases 44 having information on the human ergonomics. For example, ergonomic information may be used to categorize parts that may be manually removed without cranes or other lifting tools, and parts that require cranes and lifting tools for removal. The software system may access databases having information on the weight of a part and information on the amount of weight that can be safely lifted by a worker, such as the weight that can be placed on the spine of a worker. If the weight of the part is too great, the system may suggest lifting tools for moving the part. The information collected from the databases is used to plan safe methods to dismantle and remove parts from the airframe.

Ergonomic information may also be used to determined the period or cost for the labor to remove parts from an airframe. For example, the software system may access databases to obtain information regarding the manual steps used to assemble the part in the airframe and a database 44 of the tools available to the disassembler. The software system may use the labor to assemble a part as a benchmark to estimate the labor cost or period needed to remove the part. The software system may also indicate which tools are needed to remove a part. The software system may also generate an assessment 46 of whether it is practical to remove the part from the airframe and an estimated cost for removal of the part. The software system may also generate, e.g., print, instructions and drawings of the steps for removing the pa

The process 46 of determining the value of potentially recoverable parts and the cost to recover the parts is repeated for each of the parts in the airframe that are candidates for recovery. A database 48 is populated with the market price and cost of removal for each part. The enhanced DMU accesses the database 48 to assign a valuation, e.g., the difference between the market price and cost of removal, for various parts in the airframe. The valuation is stored in the database 48 of valuation. The enhanced DMU displays those parts having a positive valuation or a valuation greater than a threshold value, e.g., a high valuation.

An initial determination 50 is made as to the locations on the airframe where a cutting tool will slice through the airframe. This initial determination is based minimizing damage to parts having a positive valuation or a valuation.

The locations for cutting through the airframe may include setting cutting planes through the airframe. The DMU digital mock-up of the airframe, and other conventional 3D CAD software systems, is used to electronically manipulate the cutting locations on the airframe and simulate the sections of the airframe based on the planes cut through the airframe. After the locations on the airframe to be cut are selected, the enhanced DMU models the locations of the cuts and indicates 52, e.g., displays, the hydraulic and other fluid lines in the airframe to be sliced in making the cuts. The digital mock-up in the DMU in conjunction with conventional 3D CAD modeling systems may locate the intersections between the cutting planes and conduits and parts in the airframes.

The intersections indicate where conduits and parts are to be cut or otherwise damaged during the cutting process. The software system may highlight the conduits and parts which intersect the cutting plans. The highlighted conduits and parts may be limited to those having hazardous materials, such as hydraulic fluid. The industry standard identifiers, e.g., identifiers consistent with the ATA-chapter standards, may be used by the software system to identify the conduits and parts having hydraulic fluid.

Cutting hydraulic and fluid lines raises the risk that hazardous fluids will leak from the aircraft. In view of the identification of hydraulic lines that would be cut in making a cut through the airframe, the human disassembler may shift the cutting lines to reduce or eliminate the cutting of hydraulic lines. The disassembler determines 54 whether to accept the initial cut locations or to adjust the cut locations to avoid cutting certain hydraulic and other fluid lines. The disassembler accepts or the DMU automatically accepts the locations of the cuts to be made through the airframe when a balance is reached between the valuation of the recoverable parts and recyclable scrap. The recycling value of scrap depends in part on the segregation of the airframe, as many materials in the airframe can be recycled easily and profitably but not necessarily together. The cost of cutting the airframe is another factor affecting the value of scrap material. The cuts may not be physically made to the airframe until after the full analysis of the valuation of the airframe is completed. The location of the cuts may be adjusted in subsequent steps of the analysis.

The cutting of the airframe will segment the airframe into sections. The software system associated with or included in the enhanced DMU may generate 56 bills-of-materials that list the parts which are to be recovered for each section of the airframe. The bill-of-materials is limited to those parts having a positive valuation or a high valuation. The bill-of-materials is stored in a database accessible to the DMU and used as a listing of parts which is removed and sold for recycling.

The bill-of-materials of recoverable parts is used to determine 58 a recycling valuation for each section of the airframe. The determination of a value for each section may involve a computation of the total valuation of all of the recoverable parts in the section and the scrap value of the portion of the section that is not included in the re-usable parts. The total valuation may include deductions for the costs of cutting the airframe into the section, the removal of the parts to be resold as spare parts, and the cost of treating hazardous or non-recyclable materials in the section.

The determination 58 of a total valuation of a section of the airframe is made with the assistance or automatically by the software system associated or included with the enhanced DMU. The software system accesses databases 34 regarding the costs of treating hazardous wastes, the database 48 storing information regarding the types and amount of hazardous wastes and accessing an electronic commerce system 24, e.g., an website based bidding system, to determine the valuation of each recoverable part in the section. The valuation of individual parts may be based on information obtained from the valuation database 48. The disassembler includes the estimated costs 60 to cut or otherwise section the airframe in the calculation of the total valuation of the section. The cost of cutting airframes is often best known to the disassembler, who enters the cost data 60.

In view of the total valuation of an airframe section, the disassembler may revisit 62 the determination of the locations of the cuts in the airframe and adjust the location of the cuts. Because the cuts have not yet been performed, the location of the cuts may be adjusted to optimize the total valuation of a section. If the cuts are adjusted, the enhanced DMU and software system repeats 64 the process steps for establishing the cutting locations on the airframe and determining the total valuation of each section of the airframe.

After the locations of the cuts through the airframe have been finally established and the total valuation of the section determined, the parts to be recovered from each section of the airframe are identified and listed in a report or database. This identification is based on a review of the bill-of-materials for the section and the valuation of each part in the section generated in steps 56 and 58.

A determination 66 is made as to the recyclable parts in each section of the airframe. The recycling value (step 58) for each part is used by the software system to identify the parts to be recycled. In addition, parts which were not selected for recycling in step 38, is reevaluated for recycling in view of the cutting planes. The cost of recovery of a part is reduced because the cutting planes provide easy access to the part. The reduction in the cost of recovering of apart may be sufficient to economically justify recovering and reselling the part.

If no parts in the section are selected for recovery 66, the process proceeds directly to a final determination 68 of the total valuation of the section of the airframe—which may be limited to the scrap value of the section with deductions for the costs of cutting and treating hazardous materials. Once the total valuation of the section is determined, the system and method is completed 70 for the respective section of the airframe.

For those sections having parts to be recovered (see step 66), the software system repeats the process 72 of simulating the process for disassembling the section to recover the part based on the digital mock-up of the section generated by the DMU and the stored information regarding the assembly process for the part. The disassembly process may proceed differently than the assembly process as the sectioning of the airframe aids in reaching the part for removal.

A disassembler is assisted by the DMU and the software system to prepare drawings and process steps 74 for disassembly of the part from the section. Conventional 3D CAD software systems used to generate assembly instructions for parts in an airframe and the ergonomics associated with part assembly is applied to disassembly parts from a section of the aircraft. The disassembly instructions are prepared based on the available tools as indicated by a tools database 44 and the human ergonomics steps needed to remove the part from the section.

Cutting the aircraft into sections or dismantling portions of the aircraft to remove a part may provide access to a part which was previously determined to be too expensive to remove. The cost of removing a part after sectioning the aircraft or after another part has been removed may be substantially cheaper than the cost of removing the part without the access provided by sectioning the aircraft or removing the other part. The software system makes another determination 76 as to whether the market value of any other parts in the section exceeds the costs of removing the part after the aircraft has been sectioned and after plans have been generated for removing other parts. This determination may also be manually made by the disassembler. A plan and drawings are generated 72 for the parts newly designated to be removed and recycled.

After all of recyclable parts are identified for removal, the software system assists the disassembler in determining 68 the total value of the parts to be recycled and the scrap value of the remaining material in each section. The scrap value of a section is determined based on the amount and value of the various metals in the section. The scrap value is discounted to account for the cost to segregate the metals in the section, the contamination, e.g., non-metallic chemicals, in the section, and the cost to form or shape the section for use as scrap. The software system may obtain information regarding the various metals in a section and the mass or weight of each type of metal from the digital mock-up in the enhanced DMU and databases 16 on the materials in the parts of the airframe. The software system may access databases or other sources of information regarding the resale value of the various metals, and compute the estimated resale value for the types and amounts of metals in each section. The software system may apply a discount to the scrap resale valuation, wherein the discount is an empirically derived constant or algorithm. The software system may also request bids from third parties for the scrap material in a section on an electronic commerce bidding site which processes sales of scrap metal.

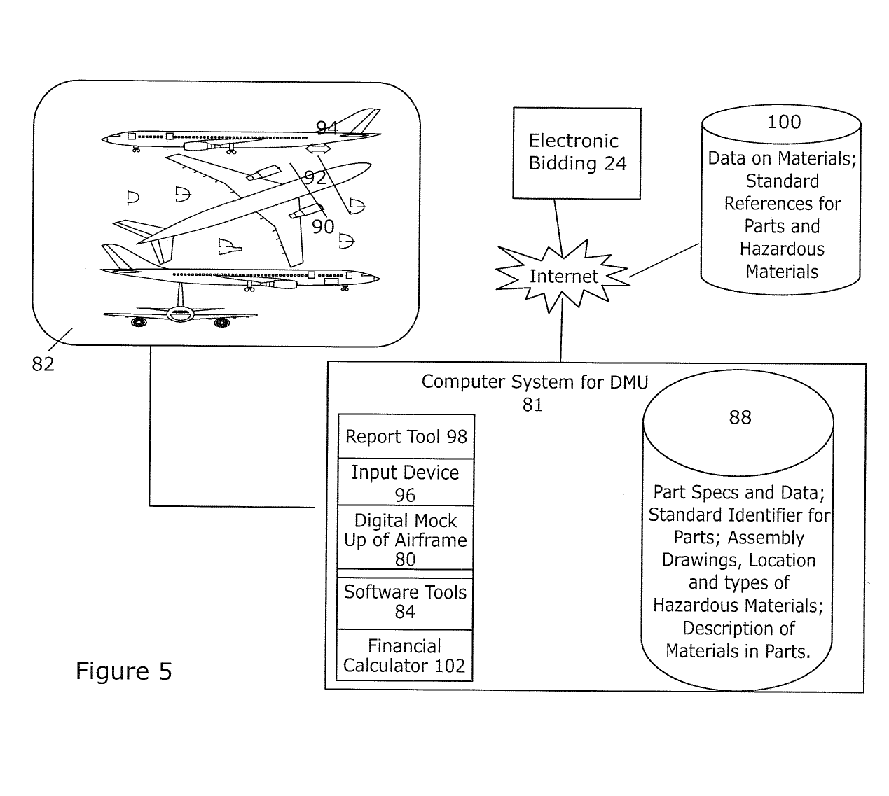

FIG. 5 is a schematic drawing of a software based system for determining the total valuation of an airframe at the end of its life and plan the dismantling of the airframe.

The airframe is modeled as a digital mock-up 80 which is shown on a display device 82 of a computer system 81 that runs the DMU and associated software systems 84. In FIG. 5 the digital mock-up is shown as a software system (module) in the computer system and, for purposes of illustration, as an image that would appear on the display. Three dimensional computer aided design (3D CAD) software 86 enables the digital mock-up to be shown from various viewpoints, including showing the airframe in cross-section and internal parts to the airframe. Data on the shape, position and assembly of parts in the airframe is included in the electronic data stored in a non-transitory memory device in the DMU system 81. The electronic data stored in the DMU includes data forming the digital mock-up and may include additional data captured from a database(s) 88 accessible by the DMU 81 while the DMU is being enhanced.

The 3D CAD software 86 is controlled to section the digital mock-up of the airframe to simulate cutting planes 90. A section 92 of the airframe is digitally simulated by making two cutting planes on opposite sides of the section. The position of the cutting planes is adjusted (see double arrows 94) by the 3D CAD software. A disassembler may adjust the cutting planes using the input device 96, such as a keyboard. The DMU analyzes the cutting planes to determine which parts of the airframe are included in the section 92 and which parts and conduits of the airframe are cut by the cutting plane.

By way of example, the software system uses the digital mock-up of the aircraft and 3D CAD modeling systems to apply the first cutting plane to split the airframe in two, retain one portion of the airframe and apply a section cutting plane to the retained portion to form a digital mock-up of a section of the airframe. The section models the actual section of the airframe formed by making the physical cuts through the airframe at the cutting locations corresponding to the first and second cutting plates. The process of applying two cutting planes to form a digital mock-up of a section is formed until the entire airframe has been segmented into sections.

The DMU 81 includes report generation software systems 98 to, for example, create bills-of-material of the parts in a section of the airframe. To generate reports the DMU collects remote information over the internet from electronic commerce data sites 24 and external data sources that includes databases of the chemical properties of materials used in the parts, industry standard procedures for identifying aircraft parts and information on hazardous wastes in the parts of the aircraft. The DMU 81 may include financial calculator tools 102 to compute valuations of the parts based on the market price of a part and the calculated costs of recovering the part and treating hazardous wastes.

The report generating software system 98 may create tables or other reports identifying the materials, e.g., hazardous materials, present in the various parts of a section of the airframe. The reporting software system automates the generating of bills-of-material, tables and reports to provide documentation of a section to be used to recover and value parts in the section.

For each digital mock-up of a section 94, the enhanced DMU determines which parts remain in the section, estimates the volume of each of the remaining parts, accesses information, such as databases, to determine the material(s) in each of the remaining parts, and computes the weight of each type of material based on the volume of the material and its density. The weights of each type of material from all of the remaining parts in the section are summed to calculate a total weight of each type of material. The enhanced DMU generates a report including a table listing for each type of materials the amount (weight) of the material and its estimated discounted market price. The total value of all types of materials in a section would be the scrap value of the section. The DMU would calculate the scrap value for each section of the airframe.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method to develop a plan to dismantle an airframe comprising:
enhancing a digital mock-up model (DMU) of the airframe with data identifying hazardous materials in parts of the airframe;
positioning at least one cut through the DMU of the airframe;
based on the position of the cut, identifying intersections between the cut and fluid conduits identified in the DMU of the airframe;
analyzing the identified intersections of the fluid conduits and data regarding hazardous waste fluids in the conduits of the airframe to identify the conduits having the hazardous waste which would be ruptured by the positioned cut, and
generating a report of the identified conduits that would be ruptured and have the hazardous waste.

2. The method of claim 1 further comprising reducing the ruptured conduits having hazardous wastes by shifting the at least one cut to another location on the airframe.

3. The method of claim 2 further comprising repeating the steps of indentifying the intersections, analyzing the identified intersections and generating a report based on the cut at the another location.

4. The method of claim 1 further comprising calculating a value of at least one part in the section based on a market price for the part from which is deducted a cost of removal of the part from the airframe and a cost of treating the hazardous waste associated with recovering the part.

5. The method of claim 1 wherein the enhancing of the DMU occurs before the airframe is placed in service and the identifying of the cuts to the airframe occurs during end-of-life processing of the airframe.

6. A system for planning a dismantling of an airframe comprising:
a computer system having a non-transitory memory storing a software system which causes the computer system to:
enhance a digital mock-up model (DMU) of an airframe, with data identifying hazardous materials in parts of the airframe;
position at least one cut through the DMU of the airframe;
based on the position of the cut, identifying intersections between the cut and fluid conduits identified in the DMU of the airframe;
analyze the identified intersections of the fluid conduits and data regarding hazardous waste fluids in the conduits of the airframe to identify the conduits having the hazardous waste which would be ruptured by the positioned cut, and
generate a report of the identified conduits that would be ruptured and have the hazardous waste.

7. The system of claim 6 wherein the software system further causes the computer system to shift the cut on the DMU of the airframe to reduce the ruptured conduits having hazardous wastes.

8. The system of claim 7 wherein the software system further causes the computer system to repeat the steps of indentifying the intersections, analyzing the identified intersections and generating a report based on the cut at the another location.

9. The system of claim 6 wherein the software system further causes the computer system calculate a value of at least one part in the section based on a market price for the part from which is deducted a cost of removal of the part from the airframe and a cost of treating the hazardous waste associated with recovering the part.

10. The system of claim 6 wherein the software system further causes the computer system to perform the enhancement of the DMU occurs before the airframe is placed in service and the identification of the cuts to the airframe during end-of-life processing of the airframe.
